(19) United States
(12) Patent Application Publication
(10) Pub. No.: US 2023/0352837 A1
(43) Pub. Date: Nov. 2, 2023

(54) PATCH ANTENNA

(71) Applicant: City University of Hong Kong, Kowloon (HK)

(72) Inventors: Kwai Man LUK, Kowloon (HK); Jie SUN, Kowloon (HK)

(21) Appl. No.: 17/731,478

(22) Filed: Apr. 28, 2022

(51) Int. Cl. H01Q 9/04; H01Q 1/48

(52) U.S. Cl. CPC H01Q 9/0407; H01Q 1/48

(57) ABSTRACT

A patch antenna includes: a patch arrangement; a ground plane; a dielectric substrate disposed between the patch arrangement and the ground plane; and a feed mechanism for feeding the patch antenna. The patch arrangement comprises a substantially-transparent dielectric layer and a substantially-transparent electrically-conductive layer that at least partly overlap in plan view.

### TECHNICAL FIELD

The invention relates to a patch antenna and a related antenna array.

### BACKGROUND

Patch antennas usually have relatively low profile structures and are suitable for mounting on surfaces.

### SUMMARY OF THE INVENTION

In a first aspect, there is provided a patch antenna comprising: a patch arrangement; a ground plane; a dielectric substrate disposed between the patch arrangement and the ground plane; and a feed mechanism for feeding the patch antenna. The patch arrangement comprises a substantially-transparent dielectric layer and a substantially-transparent electrically-conductive layer that at least partly overlap in plan view.

The substantially-transparent dielectric layer may have a transparency or light transmittance (in respect of visible light) of over 70%, over 75%, over 80%, over 85%, over 90%, over 95%, or about 100%. The substantially-transparent electrically-conductive layer may have a transparency or light transmittance (in respect of visible light) of over 70%, over 75%, over 80%, over 85%, over 90%, over 95%, or about 100%.

Optionally, the substantially-transparent electrically-conductive layer is thinner than the substantially-transparent dielectric layer.

The substantially-transparent dielectric layer and a substantially-transparent electrically-conductive layer may completely overlap in plan view.

In one example, in plan view, the substantially-transparent dielectric layer defines a first outline and the substantially-transparent electrically-conductive layer defines a second outline substantially identical to the first outline. In another example, in plan view, the first outline is within the second outline. In yet another example, in plan view, the second outline is within the first outline.

The substantially-transparent electrically-conductive layer may include one or more solid materials.

Optionally, the substantially-transparent electrically-conductive layer comprises an electrically-conductive film made of one or more solid materials. In one example, the substantially-transparent electrically-conductive layer consists of an electrically-conductive film. For example, the electrically-conductive film may include a AgHT-4 film, a AgHT-8 film, etc. Optionally, the electrically-conductive film may include any transparent conducting films (TCFs).

Optionally, the substantially-transparent electrically-conductive layer comprises an electrically-conductive mesh or mesh sheet made of one or more solid materials. In one example, the substantially-transparent electrically-conductive layer consists of the electrically-conductive mesh or mesh sheet. The electrically-conductive mesh or mesh sheet has holes, e.g., through-holes. The holes or through-holes can have any shape, e.g., rectangular- or square-shaped, in plan view. The holes or through-holes may have substantially the same size or two or more different sizes. The holes or through-holes of the mesh may be formed by etching or cutting the substantially-transparent electrically-conductive layer.

Optionally, the electrically-conductive mesh is made of a conductive oxide. For example, the conductive oxide may include indium-tin oxide (ITO), fluorine-doped tin oxide (FTO), indium—zinc—tin oxide (IZTO), etc. Optionally, the conductive oxide may be any transparent conducting oxide (TCO).

Optionally, the substantially-transparent dielectric layer comprises a liquid layer. In one example, the substantially-transparent dielectric layer consists of the liquid layer. Optionally, the liquid layer comprises a water layer. In one example, the liquid layer consists of a water layer. The water layer may be a pure water (e.g., not salt water) or distilled water layer.

Optionally, the substantially-transparent dielectric layer include one or more solid materials.

Optionally, the patch arrangement, considering all material(s) forming it, is substantially-transparent. The patch arrangement may have a transparency or light transmittance (in respect of visible light) of over 70%, over 75%, over 80%, over 85%, over 90%, over 95%, or about 100%. The patch arrangement may consist of only the substantially-transparent dielectric layer and the substantially-transparent electrically-conductive layer.

In one example, the substantially-transparent dielectric layer is disposed between the dielectric substrate and the substantially-transparent electrically-conductive layer. In another example, the substantially-transparent electrically-conductive layer is disposed between the dielectric substrate and the substantially-transparent dielectric layer.

Optionally, the dielectric substrate, considering the material(s) forming it, is substantially-transparent. The dielectric substrate may have a transparency or light transmittance (in respect of visible light) of over 70%, over 75%, over 80%, over 85%, over 90%, over 95%, or about 100%.

Optionally, the dielectric substrate comprises a liquid layer, a gaseous layer, or a solid layer. In one example, the dielectric substrate consists of a liquid layer, a gaseous layer, or a solid layer.

Optionally, the dielectric substrate comprises an air layer. In one example, the dielectric substrate consists of an air layer.

Optionally, the dielectric substrate comprises a glass layer. In one example, the dielectric substrate consists of a glass layer.

Optionally, the dielectric substrate comprises a thermoplastic layer. In one example, the dielectric substrate consists of a thermoplastic layer. The thermoplastic layer may be a plexiglass layer.

Optionally, the ground plane, considering the material(s) forming it, is substantially-transparent. The ground plane may have a transparency or light transmittance (in respect of visible light) of over 70%, over 75%, over 80%, over 85%, over 90%, over 95%, or about 100%.

Optionally, the ground plane comprises a metallic layer, which may not be substantially-transparent. In one example, the ground plane consists of a metallic layer. The metallic layer may be made of copper, aluminium, etc.

Optionally, the ground plane comprises a substantially-transparent dielectric layer. In one example, the ground plane consists of a substantially-transparent dielectric layer. The substantially-transparent dielectric layer of the ground plane may have a transparency or light transmittance (in respect of visible light) of over 70%, over 75%, over 80%, over 85%, over 90%, over 95%, or about 100%.

Optionally, the substantially-transparent dielectric layer of the ground plane comprises a liquid layer. In one example, the substantially-transparent dielectric layer of the ground plane consists of the liquid layer. Optionally, the liquid layer comprises a water layer. In one example, the liquid layer consists of a water layer. The water layer may be a pure water (e.g., not salt water) or distilled water layer.

Optionally, the substantially-transparent dielectric layer of the ground plane include one or more solid materials.

Optionally, the ground plane further comprises a substantially-transparent 3o electrically-conductive layer. The substantially-transparent electrically-conductive layer may have a transparency or light transmittance (in respect of visible light) of over 70%, over 75%, over 80%, over 85%, over 90%, over 95%, or about 100%. The substantially-transparent dielectric layer of the ground plane and the substantially-transparent electrically-conductive layer of the ground plane at least partly overlap in plan view. In one example, the substantially-transparent dielectric layer of the ground plane and the substantially-transparent electrically-conductive layer of the ground plane completely partly overlap in plan view. In one example, the ground plane consist of the substantially-transparent dielectric layer and the substantially-transparent electrically-conductive layer.

In one example, in plan view, the substantially-transparent dielectric layer of the ground plane defines a first outline and the substantially-transparent electrically-conductive layer of the ground plane defines a second outline substantially identical to the first outline. In another example, in plan view, the first outline is within the second outline. In yet another example, in plan view, the second outline is within the first outline. Optionally, the substantially-transparent electrically-conductive layer of the ground plane is thinner than the substantially-transparent dielectric layer of the ground plane.

Optionally, the substantially-transparent electrically-conductive layer of the ground plane comprises one or more solid materials.

Optionally, the substantially-transparent electrically-conductive layer of the ground plane comprises an electrically-conductive film made of one or more solid materials. In one example, the substantially-transparent electrically-conductive layer of the ground plane consists of an electrically-conductive film. For example, the electrically-conductive film may include a AgHT-4 film, a AgHT-8 film, etc. Optionally, the electrically-conductive film may include any transparent conducting films (TCFs).

Optionally, the substantially-transparent electrically-conductive layer of the ground plane comprises an electrically-conductive mesh or mesh sheet made of one or more solid materials. In one example, the substantially-transparent electrically-conductive layer of the ground plane consists of the electrically-conductive mesh or mesh sheet. The electrically-conductive mesh or mesh sheet has holes, e.g., through-holes. The holes or through-holes can have any shape, e.g., rectangular- or square-shaped, in plan view. The holes or through-holes may have substantially the same size or two or more different sizes. The holes or through-holes of the mesh may be formed by etching or cutting the substantially-transparent electrically-conductive layer.

Optionally, the electrically-conductive mesh is made of a conductive oxide. For example, the conductive oxide may include indium-tin oxide (ITO), fluorine-doped tin oxide (FTO), indium-zinc-tin oxide (IZTO), etc. Optionally, the conductive oxide may be any transparent conducting oxide (TCO).

In one example, the substantially-transparent dielectric layer of the ground plane is disposed between the dielectric substrate and the substantially-transparent electrically-conductive layer of the ground plane. In another example, the substantially-transparent electrically-conductive layer of the ground plane is disposed between the dielectric substrate and the substantially-transparent dielectric layer of the ground plane.

The feed mechanism is arranged for connection with a signal receiver and/or transmitter, to operably couple the signal receiver and/or transmitter with the patch antenna.

Optionally, the feed mechanism comprises a probe feed mechanism that includes a feed probe arranged at least partly in the dielectric substrate, and, in plan view, the patch arrangement and the feed probe at least partly overlap. In one example, the feed probe arranged is arranged substantially entirely in the dielectric substrate. In one example, the patch arrangement and the feed probe substantially entirely overlap in plan view. The probe feed mechanism does not directly contact the patch arrangement.

Optionally, the feed probe is a straight feed probe that extends generally perpendicular to the dielectric substrate.

Optionally, the feed probe is an L-shaped feed probe that has a first portion and a second portion extending generally perpendicularly from the first portion. The first portion may extend generally perpendicular to the dielectric substrate and the second portion may extend generally parallel to the dielectric substrate.

Optionally, the feed probe is a disc-loaded feed probe (which has a T-shaped cross section when view from the side). The disc-loaded feed probe includes a probe portion that extends generally perpendicular to the dielectric substrate, and a disc-shaped portion connected at a top end of the probe portion and extending generally perpendicularly to the probe portion. The probe portion and the disc-shaped portion are generally coaxial. The disc-shaped portion may comprise a generally circular disc.

Optionally, the feed probe is a hook-shaped feed probe that has a first portion, a second portion extending generally perpendicularly from the first portion, and a third portion extending generally perpendicularly from the second portion and generally parallel to the first portion. The first and third portions may extend generally perpendicular to the dielectric substrate and the second portion may extend generally parallel to the dielectric substrate. In one example, the first portion extends along a first direction, the second portion extends along a second direction generally perpendicular to the first direction, and the third portion extends along a third direction generally opposite to the first direction. The third portion may be shorter than the first portion.

Optionally, the feed mechanism further comprises a feed connector connected with the feed probe (e.g., straight feed probe, L-shaped feed probe, disc-loaded feed probe, hook-shaped feed probe), the feed connector extends at least partly through the ground plane. The feed connector may comprise a coaxial cable connector (e.g., SMA connector).

Optionally, the feed mechanism comprises a stripline feed mechanism. In one example, the stripline feed mechanism includes a stripline connected with the patch arrangement. The stripline and the patch arrangement may be arranged on the same side of the dielectric substrate. The stripline may be a substantially-transparent 3o conductor. Optionally, the feed mechanism further comprises a feed connector connected with the stripline. The feed connector may comprise a SMA connector/probe.

Optionally, the feed mechanism comprises an aperture feed mechanism. In one example, the aperture feed mechanism includes: a coupling aperture formed in the ground plane, and a feed line operably coupled with the coupling aperture. The aperture feed mechanism may further include a feed substrate on which the feed line 5 is arranged. Optionally, the feed substrate is disposed between the feed line and the ground plane. The feed line may be a substantially-transparent conductor. The feed substrate may be substantially-transparent. Optionally, the feed mechanism further comprises a feed connector connected with the feed line. The feed connector may comprise a SMA connector/probe.

Optionally, the patch arrangement, the ground plane, and the dielectric substrate are all substantially-transparent. The feed mechanism may or may not be substantially-transparent. The feed mechanism may partly be substantially-transparent.

Optionally, the patch antenna, considering the material(s) forming it, is an optically transparent patch antenna or an optically substantially-transparent patch antenna. In one example, the patch antenna has a transparency or light transmittance (in respect of visible light) of at least 80%, preferably over 85%, or more preferably over 90%.

In some examples, in plan view: the patch arrangement may occupy a smaller footprint than the ground plane and the dielectric substrate; the ground plane may occupy a smaller footprint than or the same footprint as the dielectric substrate.

In some examples, the patch arrangement may be generally flat with a thickness or average thickness (e.g., in the order of mm or cm). In some examples, the dielectric substrate may be generally flat with a thickness or average thickness (e.g., in the order of mm or cm). In some examples, the ground plane may be generally flat with a thickness or average thickness (e.g., in the order of mm or cm). Each layer(s) of the patch arrangement may be generally flat. Each layer(s) of the dielectric substrate may be generally flat. Each layer(s) of the ground plane may be generally flat.

In a second aspect, there is provided an antenna array comprising a plurality of patch antennas of the first aspect. Optionally, the ground plane of two or more or all of the patch antennas in the antenna array are connected together or integrally formed as a larger ground plane. Optionally, the dielectric substrate of two or more or all of the patch antennas in the array are connected together or integrally formed as a larger dielectric substrate. Optionally, each patch antenna unit its own feed mechanism. Alternatively, two or more of the patch antennas share the same feed mechanism.

In a third aspect, there is provided an antenna array comprising a plurality of patch antenna units. Each of the plurality of patch antenna units include: a patch arrangement; a ground plane; a dielectric substrate disposed between the patch arrangement and the ground plane; and a feed mechanism for feeding the patch antenna unit. The patch arrangement comprises a substantially-transparent dielectric layer and a substantially-transparent electrically-conductive layer that at least partly overlap in plan view. Optionally, the ground plane of two or more or all of the patch antenna units are connected together or integrally formed as a larger ground plane. Optionally, the dielectric substrate of two or more or all of the patch antenna units are connected together or integrally formed as a larger dielectric substrate. Optionally, each patch antenna unit has its own feed mechanism. Alternatively, two or more of the patch antenna units share the same feed mechanism.

In a fourth aspect, there is provided a communication device comprising a patch antenna of the first aspect. The communication device is arranged for cellular communication, such as 5G, 6G, or above generation communication.

In a fifth aspect, there is provided a communication device comprising an antenna array of the second aspect. The communication device is arranged for cellular communication, such as 5G, 6G, or above generation communication.

In a sixth aspect, there is provided a communication device comprising an antenna array of the third aspect. The communication device is arranged for cellular communication, such as 5G, 6G, or above generation communication.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

Terms of degree such that “generally”, “about”, “substantially”, or the like, are, depending on context, used to take into account manufacture tolerance, degradation, trend, tendency, practical applications, etc. Unless otherwise specified, “substantially-transparent” as used herein may refer to a transparency or light transmittance (in respect of visible light) of over 70%, and “transparent” may refer to a transparency or light transmittance (in respect of visible light) of over 85%.

Unless otherwise specified, the terms “connected”, “coupled”, “mounted”, “attached” or the like, encompass both direct and indirect connection, coupling, mounting, attachment, etc.

### BRIEF DESCRIPTION OF THE DRAWINGS

Embodiments of the invention will now be described, by way of example, with reference to the accompanying drawings in which:

FIG. 1A is a schematic diagram of a patch antenna in one embodiment of the invention;

FIG. 1B is a side view of the patch antenna of FIG. 1A;

FIG. 2A is a schematic diagram of a patch antenna in one embodiment of the invention;

FIG. 2B is a side view of the patch antenna of FIG. 2A;

FIG. 3A is a schematic diagram of a patch antenna in one embodiment of the invention;

FIG. 3B is a side view of the patch antenna of FIG. 3A;

FIG. 4A is a schematic diagram of a patch antenna in one embodiment of the invention;

FIG. 4B is a side view of the patch antenna of FIG. 4A;

FIG. 5A is a schematic diagram of a patch antenna in one embodiment of the invention;

FIG. 5B is a side view of the patch antenna of FIG. 5A;

FIG. 6A is a schematic diagram of a patch antenna in one embodiment of the invention;

FIG. 6B is a side view of the patch antenna of FIG. 6A;

FIG. 7A is a schematic diagram of a patch antenna in one embodiment of the invention;

FIG. 7B is a top view of the patch antenna of FIG. 7A;

FIG. 7C is a side view of the patch antenna of FIG. 7A;

FIG. 7D is a schematic diagram of the patch antenna of FIG. 7A illustrating some of the key dimensions of the patch antenna;

FIG. 8 is a graph illustrating the S-parameter and gain of the patch antenna of FIG. 7A at different frequencies;

FIG. 9 is a Smith chart showing of the simulated radiation pattern of the patch antenna of FIG. 7A at 1.8 GHz;

FIG. 10 is a Smith chart showing of the simulated radiation pattern of the patch antenna of FIG. 7A at 2.0 GHz;

FIG. 11 is a Smith chart showing of the simulated radiation pattern of the patch antenna of FIG. 7A at 2.4 GHz;

FIG. 12 is a schematic diagram of the patch antenna of FIG. 3A incorporating a straight probe feed;

FIG. 13 is a schematic diagram of the patch antenna of FIG. 3A incorporating a L-shaped probe feed;

FIG. 14 is a schematic diagram of the patch antenna of FIG. 3A incorporating a disk-loaded probe feed;

FIG. 15 is a schematic diagram of the patch antenna of FIG. 3A incorporating a hook-shaped probe feed;

FIG. 16 is a schematic diagram of the patch antenna of FIG. 3A incorporating a stripline feed;

FIG. 17 is a schematic diagram of the patch antenna of FIG. 3A incorporating a aperture-coupled feed;

FIG, 18A is a schematic diagram of a patch antenna in one embodiment of the invention;

FIG. 18B is a side view of the patch antenna of FIG. 18A;

FIG. 19A is a schematic top view of a patch arrangement in a patch antenna in one embodiment of the invention;

FIG. 19B is a schematic top view of a patch arrangement in a patch antenna in one embodiment of the invention;

FIG. 19C is a schematic top view of a patch arrangement in a patch antenna in one embodiment of the invention;

FIG. 19D is a schematic top view of a patch arrangement in a patch antenna in one embodiment of the invention;

FIG. 19E is a schematic top view of a patch arrangement in a patch antenna in one embodiment of the invention;

FIG. 19F is a schematic top view of a patch arrangement in a patch antenna in one embodiment of the invention;

FIG. 19G is a schematic top view of a patch arrangement in a patch antenna in one embodiment of the invention;

FIG. 19H is a schematic top view of a patch arrangement in a patch antenna in one embodiment of the invention;

FIG. 19I is a schematic top view of a patch arrangement in a patch antenna in one embodiment of the invention;

FIG. 19J is a schematic top view of a patch arrangement in a patch antenna in one embodiment of the invention; and

FIG. 19K is a schematic top view of a patch arrangement in a patch antenna in one embodiment of the invention.

### DETAILED DESCRIPTION

The inventors of the present invention have devised, through research, experiments, and trials, that an optically transparent patch antenna ideally has a low-profile structure and high optical transparency (e.g., to facilitate integration with substantially-transparent objects). The inventors have further devised, through research, experiments, and trials, that an optically transparent patch antenna can be formed using, among other things, transparent conductors or transparent fluid. The inventors have realized that transparent conductors generally do not have high optical transparency (especially when compared with transparent fluid), as the optical transparency and the conductivity of transparent conductor is generally negatively correlated, and a lowered conductivity will result in a lowered gain and lowered radiation efficiency of the antenna. The inventors have realized that on the other hand transparent fluid in transparent patch antenna needs to be sufficiently thick to enable higher gain and higher radiation efficiency of the antenna, but the thickness of the transparent fluid makes it difficult to provide an antenna with low-profile structure.

The inventors have realized that there is a need to provide an improved or alternative patch antenna (such as but not limited to an optically transparent patch antenna) design.

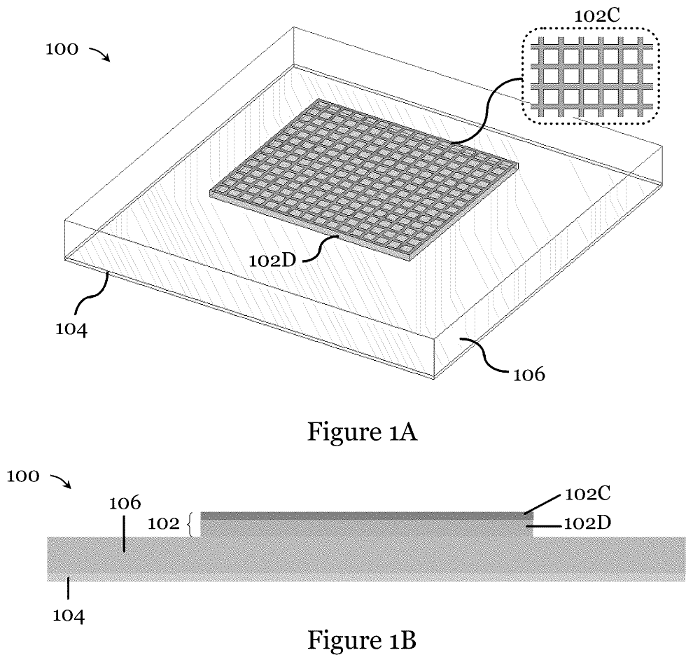

FIGS. 1A and 1B show a patch antenna 100 in one embodiment of the invention. The patch antenna 100 includes a patch arrangement 102, a ground plane 104, and a dielectric substrate 106 arranged between the patch arrangement 102 and the ground plane 104.

The patch arrangement 102 includes a substantially-transparent dielectric layer 102D and a substantially-transparent electrically-conductive layer 102C arranged on top of the substantially-transparent dielectric layer 102D such that the two layers 102D, 102C overlap in plan view. In plan view, the outline defined by the substantially-transparent dielectric layer 102D and the outline defined by the substantially-transparent dielectric layer 102D are substantially the same. The patch arrangement 102 is arranged generally centrally on the dielectric substrate 106. The substantially-transparent electrically-conductive layer 102C includes an electrically-conductive mesh made of conductive oxide such as indium-tin oxide (ITO). The mesh includes through-holes that have square or rectangular cross section in plan view. The substantially-transparent dielectric layer 102D includes a water, more specifically pure water, layer. The substantially-transparent dielectric layer 102D and the substantially-transparent electrically-conductive layer 102C are both generally flat, and the substantially-transparent dielectric layer 102D is thicker than the substantially-transparent electrically-conductive layer 102C.

The dielectric substrate 106 includes a layer of dielectric material, which in this example is air. The dielectric substrate 106 is generally flat, and is thicker than each of the patch arrangement 102 and the ground plane 104.

The ground plane 104 includes a layer of conductive material, which in this example is metal (e.g., copper, aluminum). The ground plane 104 is also generally flat, and is thinner than each of the patch arrangement 102 and the dielectric substrate 106.

In this example, all of the patch arrangement 102, ground plane 104, and the dielectric substrate 106 have a generally rectangular footprint in plan view. The rectangular footprint of the patch arrangement 102 is smaller than the rectangular footprint of the ground plane 104 and the rectangular footprint of the dielectric substrate 106. The rectangular footprint of the ground plane 104 and the rectangular footprint of the dielectric substrate 106 are substantially identical.

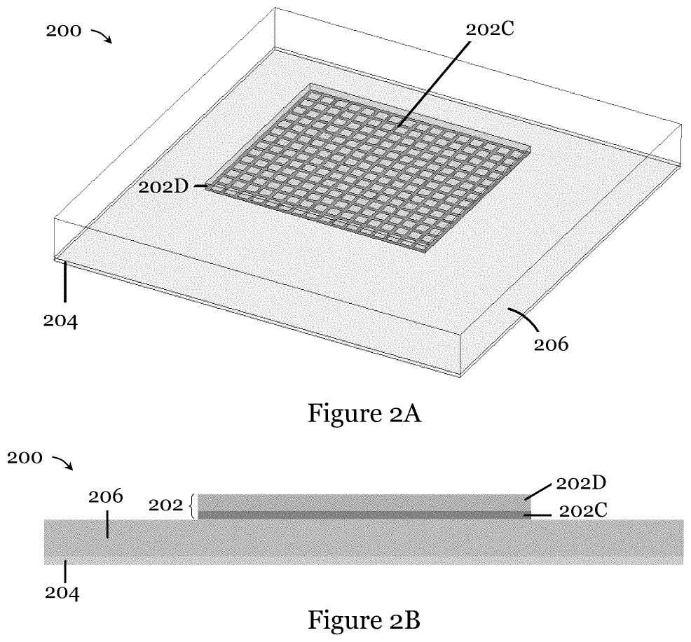

FIGS. 2A and 2B show a patch antenna 200 in one embodiment of the invention. Generally, the patch antenna 200 is the same as the patch antenna 100 of Figure IA, except that the order of the dielectric layer and electrically-conductive layer of the patch arrangement is different.

The patch antenna 200 includes a patch arrangement 202, a ground plane 204, and a dielectric substrate 206 arranged between the patch arrangement 202 and the ground plane 204.

The patch arrangement 202 includes a substantially-transparent electrically-conductive layer 202C and a substantially-transparent dielectric layer 202D arranged on top of the substantially-transparent electrically-conductive layer 202C such that the two layers 202D, 202C overlap in plan view. In plan view, the outline defined by the substantially-transparent dielectric layer 202D and the outline defined by the substantially-transparent dielectric layer 202D are substantially the same. The patch arrangement 202 is arranged generally centrally on the dielectric substrate 206. The substantially-transparent electrically-conductive layer 202C includes an electrically-conductive mesh made of conductive oxide such as indium-tin oxide (ITO). The mesh includes through-holes that have square or rectangular cross section in plan view. The substantially-transparent dielectric layer 202D includes a water, more specifically pure water, layer. The substantially-transparent dielectric layer 202D and the substantially-transparent electrically-conductive layer 202C are both generally flat, and the substantially-transparent dielectric layer 202D is thicker than the substantially-transparent electrically-conductive layer 202C.

The dielectric substrate 206 is the same as the dielectric substrate 106. The ground plane 204 is the same as the ground plane 104. The footprint arrangement of the patch antenna 200 is also the same as the patch antenna 100. For simplicity, they will not be repeated here.

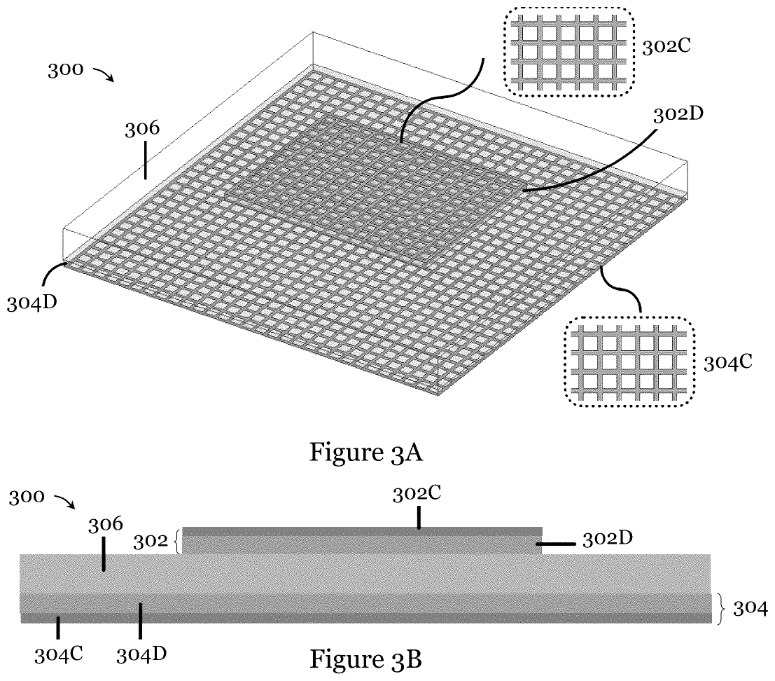

FIGS. 3A and 3B show a patch antenna 300 in one embodiment of the invention. The patch antenna 300 includes a patch arrangement 302, a ground plane 304, and a dielectric substrate 306 arranged between the patch arrangement 302 and the ground plane 304.

The patch arrangement 302 includes a substantially-transparent dielectric layer 102D and a substantially-transparent electrically-conductive layer 302C arranged on top of the substantially-transparent dielectric layer 302D such that the two layers 302D, 302C overlap in plan view. In plan view, the outline defined by the substantially-transparent dielectric layer 302D and the outline defined by the substantially-transparent dielectric layer 302D are substantially the same. The patch arrangement 302 is arranged generally centrally on the dielectric substrate 306. The substantially-transparent electrically-conductive layer 302C includes an electrically-conductive mesh made of conductive oxide such as indium-tin oxide (ITO). The mesh includes through-holes that have square or rectangular cross section in plan view. The substantially-transparent dielectric layer 302D includes a water, more specifically pure water, layer. The substantially-transparent dielectric layer 302D and the substantially-transparent electrically-conductive layer 302C are both generally flat, and the substantially-transparent dielectric layer 302D is thicker than the substantially-transparent electrically-conductive layer 302C.

The dielectric substrate 306 includes a layer of dielectric material, which in this example is air. The dielectric substrate 306 is generally flat, and is thicker than each of the patch arrangement 302 and the ground plane 304.

The ground plane 304 includes a substantially-transparent dielectric layer 304D and a substantially-transparent electrically-conductive layer 304C arranged below the substantially-transparent dielectric layer 304D such that the two layers 304D, 304C overlap in plan view. In plan view, the outline defined by the substantially-transparent dielectric layer 304D and the outline defined by the substantially-transparent dielectric layer 304D are substantially the same. The substantially-transparent electrically-conductive layer 304C includes an electrically-conductive mesh made of conductive oxide such as indium-tin oxide (ITO). The mesh includes through-holes that have square or rectangular cross section in plan view. The substantially-transparent dielectric layer 304D includes a water, more specifically pure water, layer. The substantially-transparent dielectric layer 304D and the substantially-transparent electrically-conductive layer 304C are both generally flat, and the substantially-transparent dielectric layer 304D is thicker than the substantially-transparent electrically-conductive layer 304C.

In this example, all of the patch arrangement 302, ground plane 304, and the dielectric substrate 306 have a generally rectangular footprint in plan view. The rectangular footprint of the patch arrangement 302 is smaller than the rectangular footprint of the ground plane 304 and the rectangular footprint of the dielectric substrate 306. The rectangular footprint of the ground plane 304 and the rectangular footprint of the dielectric substrate 306 are substantially identical.

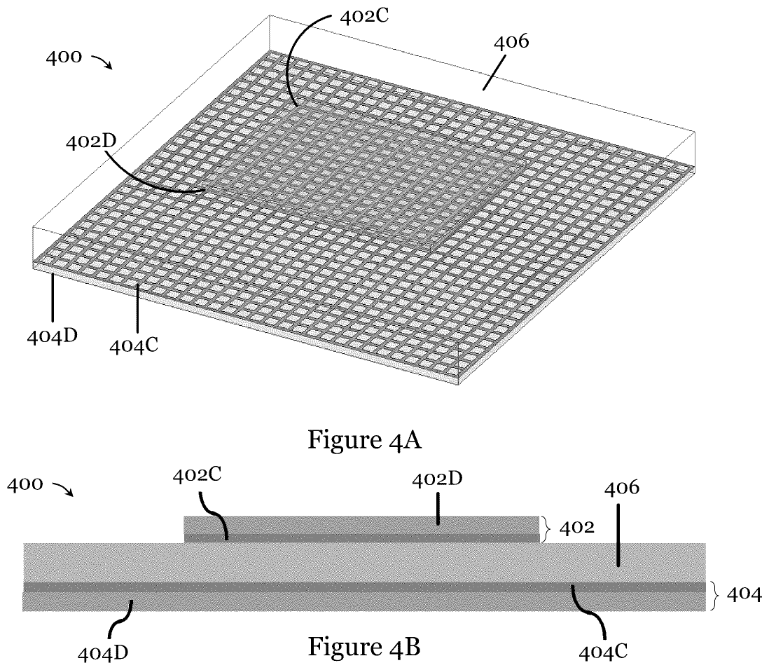

FIGS. 4A and 4B show a patch antenna 400 in one embodiment of the invention. Generally, the patch antenna 400 is the same as the patch antenna 300 of FIG. 3A, except that the order of the dielectric layer and electrically-conductive layer of the patch arrangement and the order of the dielectric layer and electrically-conductive layer of the ground plane are both different.

The patch antenna 400 includes a patch arrangement 402, a ground plane 404, and a dielectric substrate 406 arranged between the patch arrangement 402 and the ground plane 404.

The patch arrangement 402 includes a substantially-transparent electrically-conductive layer 402C and a substantially-transparent dielectric layer 402D arranged on top of the substantially-transparent electrically-conductive layer 402C such that the two layers 402D, 402C overlap in plan view. In plan view, the outline defined by the substantially-transparent dielectric layer 402D and the outline defined by the substantially-transparent dielectric layer 402D are substantially the same. The patch arrangement 402 is arranged generally centrally on the dielectric substrate 406. The substantially-transparent electrically-conductive layer 402C includes an electrically-conductive mesh made of conductive oxide such as indium-tin oxide (ITO). The mesh includes through-holes that have square or rectangular cross section in plan view. The substantially-transparent dielectric layer 402D includes a water, more specifically pure water, layer. The substantially-transparent dielectric layer 402D and the substantially-transparent electrically-conductive layer 402C are both generally flat, and the substantially-transparent dielectric layer 402D is thicker than the substantially-transparent electrically-conductive layer 402C.

The ground plane 404 includes a substantially-transparent electrically-conductive layer 404C and a substantially-transparent dielectric layer 404D arranged below the substantially-transparent electrically-conductive layer 404C such that the two layers 404D, 404C overlap in plan view. In plan view, the outline defined by the substantially-transparent dielectric layer 404D and the outline defined by the substantially-transparent dielectric layer 404D are substantially the same. The substantially-transparent electrically-conductive layer 404C includes an electrically-conductive mesh made of conductive oxide such as indium-tin oxide (ITO). The mesh includes through-holes that have square or rectangular cross section in plan view. The substantially-transparent dielectric layer 404D includes a water, more specifically pure water, layer. The substantially-transparent dielectric layer 404D and the substantially-transparent electrically-conductive layer 404C are both generally flat, and the substantially-transparent dielectric layer 404D is thicker than the substantially-transparent electrically-conductive layer 404C.

The dielectric substrate 406 is the same as the dielectric substrate 306. The footprint arrangement of the patch antenna 400 is also the same as the patch antenna 300. For simplicity, they will not be repeated here.

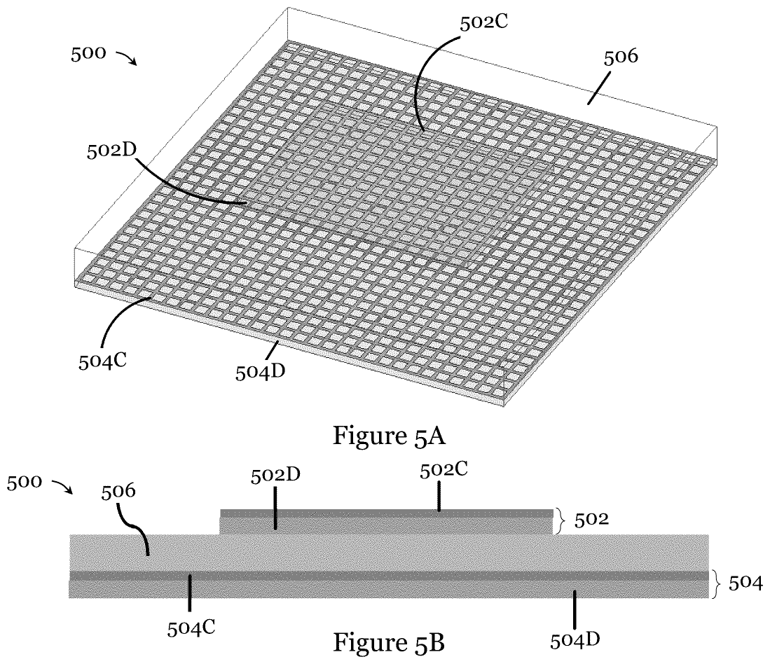

FIGS. 5A and 5B show a patch antenna 500 in one embodiment of the invention. Generally, the patch antenna 500 is the same as the patch antenna 300 of FIG. 3A, except that the order of the dielectric layer and electrically-conductive layer of the ground plane is different.

The patch antenna 500 includes a patch arrangement 502, a ground plane 504, and a dielectric substrate 506 arranged between the patch arrangement 502 and the ground plane 504. The patch arrangement 502 includes a substantially-transparent dielectric layer 502D and a substantially-transparent electrically-conductive layer 502C arranged on top of the substantially-transparent dielectric layer 502D such that the two layers 502D, 502C overlap in plan view.

The ground plane 504 includes a substantially-transparent electrically-conductive layer 504C and a substantially-transparent dielectric layer 504D arranged below the substantially-transparent electrically-conductive layer 504C such that the two layers 504D, 504C overlap in plan view. In plan view, the outline defined by the substantially-transparent dielectric layer 504D and the outline defined by the substantially-transparent dielectric layer 504D are substantially the same. The substantially-transparent electrically-conductive layer 504C includes an electrically-conductive mesh made of conductive oxide such as indium-tin oxide (ITO). The mesh includes through-holes that have square or rectangular cross section in plan view. The substantially-transparent dielectric layer 504D includes a water, more specifically pure water, layer. The substantially-transparent dielectric layer 504D and the substantially-transparent electrically-conductive layer 504C are both generally flat, and the substantially-transparent dielectric layer 504D is thicker than the substantially-transparent electrically-conductive layer 504C.

The patch arrangement 502 is the same as the patch arrangement 302. The dielectric substrate 506 is the same as the dielectric substrate 306. The footprint arrangement of the patch antenna 500 is also the same as the patch antenna 300. For simplicity, they will not be repeated here.

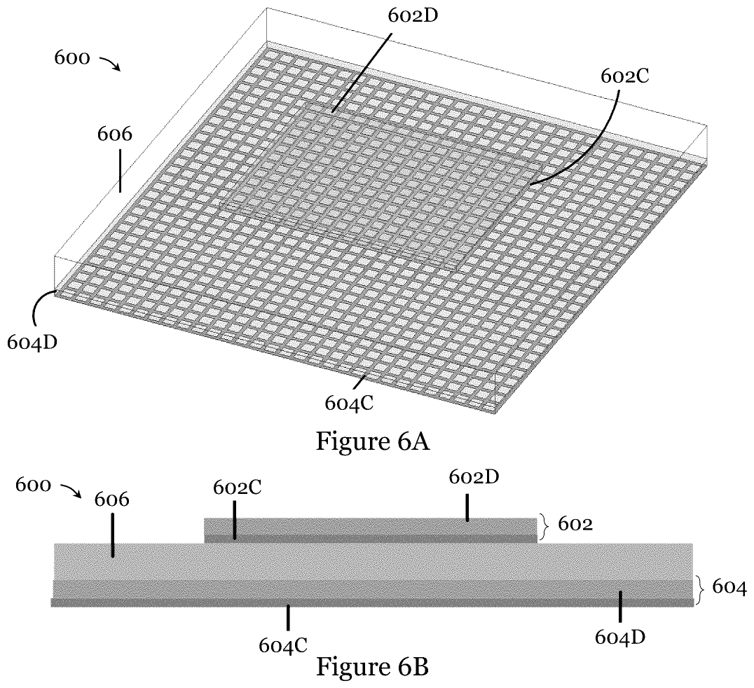

FIGS. 6A and 6B show a patch antenna 600 in one embodiment of the invention. Generally, the patch antenna 600 is the same as the patch antenna 300 of FIG. 3A, except that the order of the dielectric layer and electrically-conductive layer of the patch arrangement is different.

The patch antenna 600 includes a patch arrangement 602, a ground plane 604, and a dielectric substrate 606 arranged between the patch arrangement 602 and the ground plane 604. The ground plane 604 includes a substantially-transparent dielectric layer 604D and a substantially-transparent electrically-conductive layer 604C arranged below the substantially-transparent dielectric layer 604D such that the two layers 604D, 604C overlap in plan view.

The patch arrangement 602 includes a substantially-transparent electrically-conductive layer 602C and a substantially-transparent dielectric layer 602D and arranged on top of the substantially-transparent electrically-conductive layer 602C such that the two layers 602D, 602C overlap in plan view. In plan view, the outline defined by the substantially-transparent dielectric layer 602D and the outline defined by the substantially-transparent dielectric layer 602D are substantially the same. The patch arrangement 602 is arranged generally centrally on the dielectric substrate 606. The substantially-transparent electrically-conductive layer 602C includes an electrically-conductive mesh made of conductive oxide such as indium-tin oxide (ITO). The mesh includes through-holes that have square or rectangular cross section in plan view. The substantially-transparent dielectric layer 602D includes a water, more specifically pure water, layer. The substantially-transparent dielectric layer 602D and the substantially-transparent electrically-conductive layer 602C are both generally flat, and the substantially-transparent dielectric layer 602D is thicker than the substantially-transparent electrically-conductive layer 602C.

The ground plane 604 is the same as the ground plane 304. The dielectric substrate 606 is the same as the dielectric substrate 306. The footprint arrangement of the patch antenna 600 is also the same as the patch antenna 300. For simplicity, they will not be repeated here.

In FIGS. 1A to 6B, the patch antenna 100-600 is shown without the feed mechanism. The skilled person understands that the patch antenna 100-600 would include at least one feed mechanism. Details of some feed mechanism embodiments will be provided below.

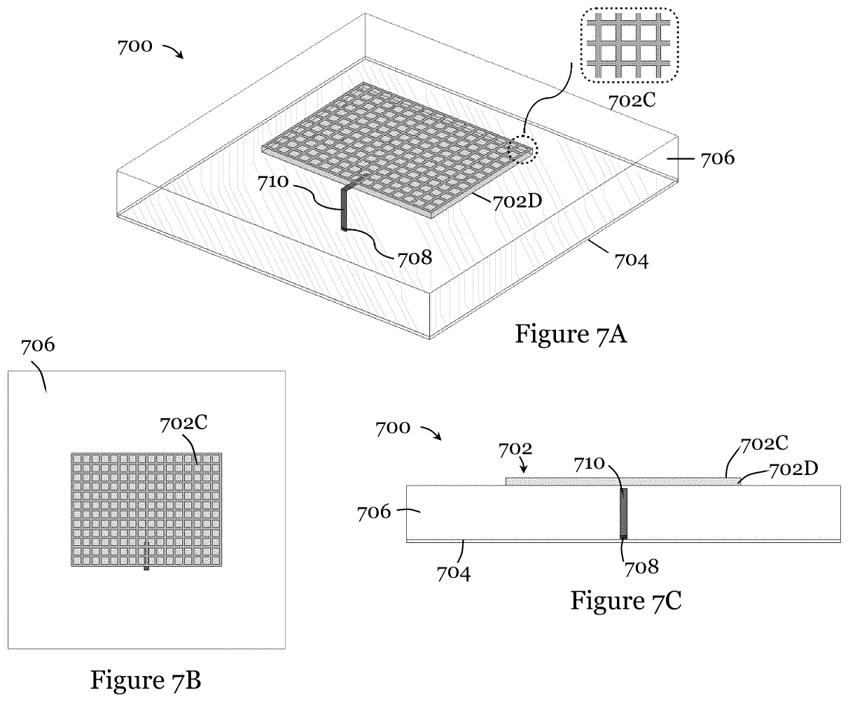

FIGS. 7A to 7D show a patch antenna 700 in one embodiment of the invention. The patch antenna 700 is a specific implementation of the patch antenna 100, with generally the same structure as the patch antenna 100. For simplicity the detailed structural and spatial relationships of various components of the antenna 700 is not repeated here.

The patch antenna 700 includes a patch arrangement 702, a ground plane 704, and a dielectric substrate 706 arranged between the patch arrangement 702 and the ground plane 704. The patch arrangement 702 includes a substantially-transparent electrically-conductive mesh layer 702C made of indium-tin oxide (ITO), that is arranged on top of a substantially-transparent pure water layer 702D. The mesh layer 702C includes through-holes with rectangular or square-shaped cross section in plan view. In this example the layers 702C, 702D form an optical patch. The dielectric substrate 706 is an air substrate (i.e., a layer of air). The ground plane 704 is a metallic ground plane. The ground plane 704 can be made of copper or aluminum. In this embodiment, the ground plane 704 facilitates unidirectional radiation of the antenna 700. The patch antenna 700 further includes a feed mechanism, which has a feed connector 708 and a metallic L-shaped feed probe 710. The feed mechanism is arranged below the patch arrangement 702 without contacting it. In this embodiment, the feed probe 710 is arranged substantially entirely in the dielectric substrate 706, and it has a first portion extending generally perpendicular to the dielectric substrate 706 and a second portion extending generally perpendicularly from the first portion and generally parallel to the dielectric substrate 706. In plan view, the patch arrangement 702 and the second portion of the feed probe 710 substantially overlap. The feed connector 708 is connected at the lower end of the first portion of the feed probe 710, between the feed probe and the ground plane 704. The feed connector 708 may be a SMA connector.

In this embodiment, the thickness of the ITO mesh layer 702C is 65 nm with a conductivity of 615000S/m. FIG. 7D illustrates various dimension parameters of the patch antenna 700. The values of these dimension parameters are shown in the table below. In the table, λ₀ is the free-space wavelength at 2.0 GHz.

| Parameter | L₁ | L₂ | L₃ | L₄ | W₁ | W₂ |
|---|---|---|---|---|---|---|
| Value (mm) | 570.38λ₀ | 30.02λ₀ | 100.067λ₀ | 140.093λ₀ | 650.43λ₀ | 10.0067λ₀ |
| (in wavelength) | | | | | | |

| Parameter | H₁ | H₂ | G | D | W₃ |
|---|---|---|---|---|---|
| Value (mm) | 20.013λ₀ | 150.1λ₀ | 1200.8λ₀ | 300.2λ₀ | 20.013λ₀ |
| (in wavelength) | | | | | |

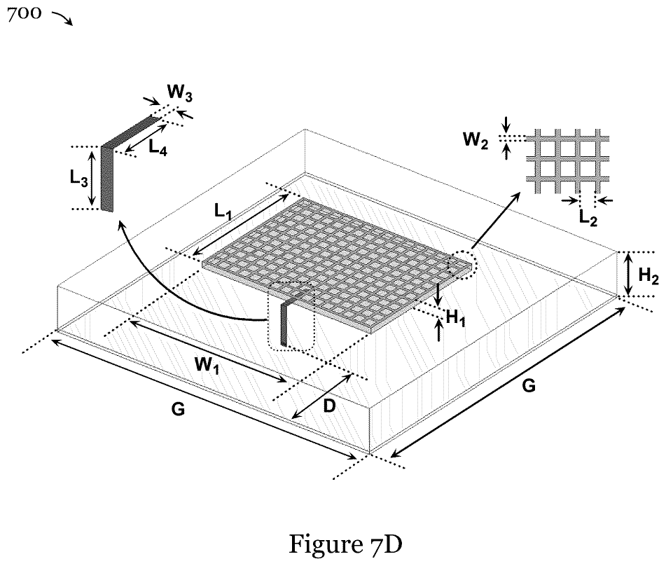

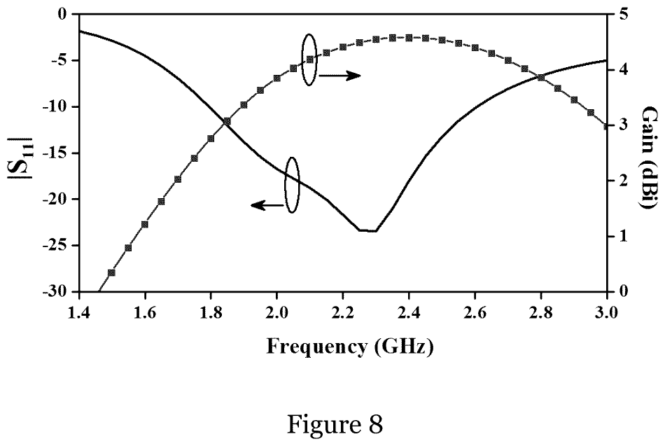

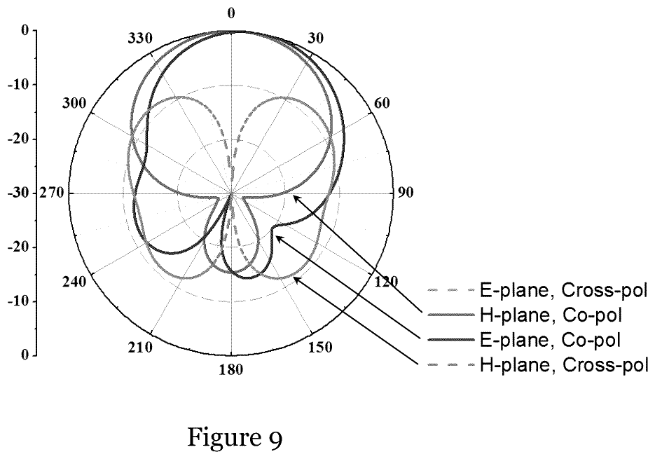

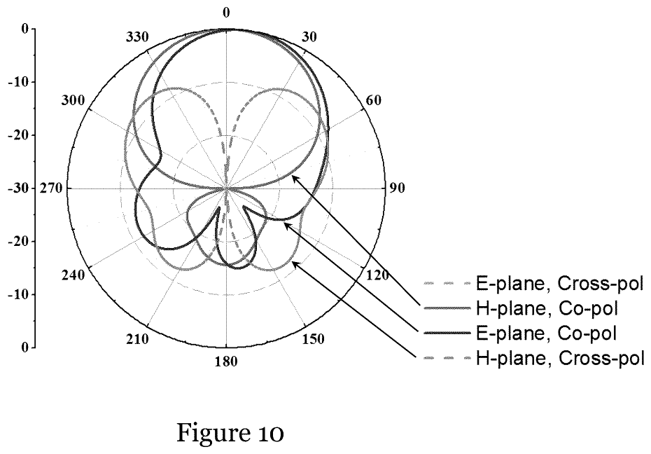

FIGS. 8 to 11 show the simulated performances of the patch antenna 700. FIG. 8 shows the |S₁₁| and gain versus frequency (1.4 to 3 GHz). As shown in FIG. 8, the simulated impedance bandwidth is 36.4% from 1.8 to 2.6 GHz with |Sᵤ|≤−10 dB; and the gain ranges from 2.8 to 4.6 dBi over the bandwidth. FIGS. 9 to 11 show the simulated radiation patterns of the patch antenna 700 at 1.8 GHz, 2.0 GHz, and 2.4 GHz respectively. It can be seen that broadside radiation pattern can be achieved at the three frequencies for both E-plane and H-plane. The back radiation level is about −15 dB. Note that in the example of FIGS. 9-11, the E-plane cross-polarization is too small to be shown.

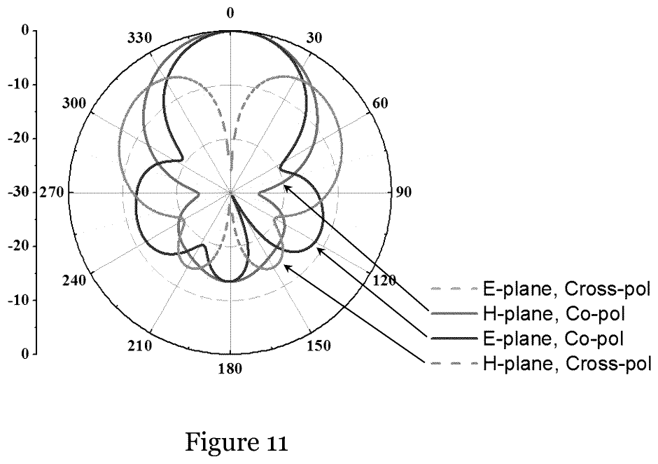

FIG. 12 shows the patch antenna 300 of FIG. 3A incorporating a straight probe feed. The structure of the patch arrangement 302, the dielectric substrate 306, and the ground plane 304 will not be repeated here. In FIG. 12, the straight probe feed comprises a feed connector 1208 and a straight feed probe 1210 electrically connected with the feed connector 1208. The feed connector 1208 extends generally perpendicular to the dielectric substrate 306 and the ground plane 304, and it extends through the ground plane 304 and partly through the dielectric substrate 306. The feed connector 1208 may be a coaxial cable connector (e.g., SMA connector). The straight feed probe 1210 extends from the feed connector 1208, generally perpendicular to the dielectric substrate 306 and the ground plane 304. The straight feed probe 1210 is arranged in the dielectric substrate 306, and does not contact the patch arrangement 302. The straight feed probe 1210 may be cylindrical. The straight feed probe 1210 may overlap with the patch arrangement 302 in plan view.

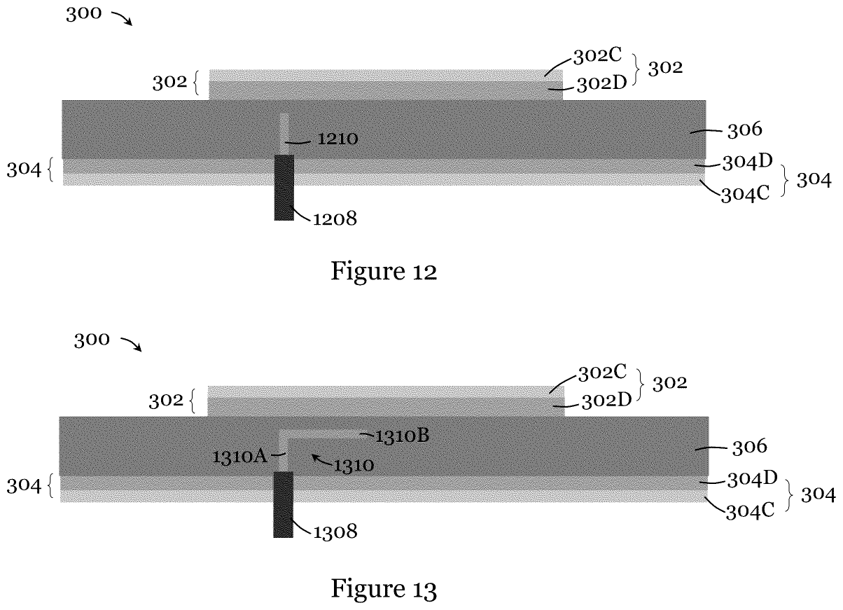

FIG. 13 shows the patch antenna 300 of FIG. 3A incorporating an L-shaped probe feed. The structure of the patch arrangement 302, the dielectric substrate 306, and the ground plane 304 will not be repeated here.

In FIG. 13, the L-shaped probe feed comprises a feed connector 1308 and an L-shaped feed probe 1310 electrically connected with the feed connector 1308. The feed connector 1308 extends generally perpendicular to the dielectric substrate 306 and the ground plane 304, and it extends through the ground plane 304 and partly through the dielectric substrate 306. The feed connector 1308 may be a coaxial cable connector (e.g., SMA connector). The L-shaped feed probe 1310 extends from the feed connector 1308. The L-shaped feed probe 1310 is arranged in the dielectric substrate 306, and does not contact the patch arrangement 302. The L-shaped feed probe 1310 includes a first portion 1310A extending generally perpendicular to the dielectric substrate 306 and a second portion 1310B extending generally parallel to the dielectric substrate 306. The second portion 1310B is longer than the first portion 1310A. The L-shaped feed probe 1310 may overlap with the patch arrangement 302 in plan view.

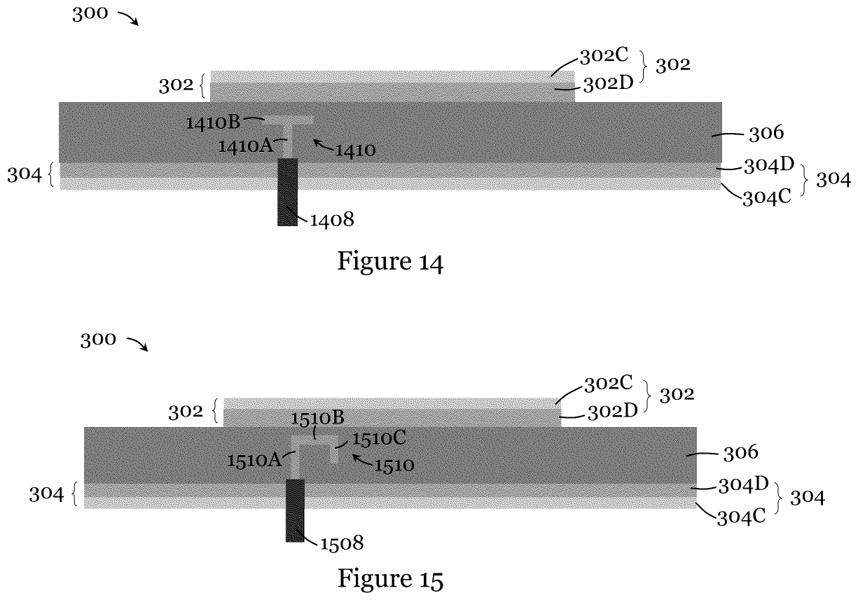

FIG. 14 shows the patch antenna 300 of FIG. 3A incorporating a disk-loaded probe feed. The structure of the patch arrangement 302, the dielectric substrate 306, and the ground plane 304 will not be repeated here.

FIG. 14, the disk-loaded probe feed comprises a feed connector 1408 and a disc-loaded feed probe 1410 electrically connected with the feed connector 1408. The feed connector 1408 extends generally perpendicular to the dielectric substrate 306 and the ground plane 304, and it extends through the ground plane 304 and partly through the dielectric substrate 306. The feed connector 1408 may be a coaxial cable connector (e.g., SMA connector). The disk-loaded feed probe 1410 extends from the feed connector 1408. The disk-loaded feed probe 1410 is arranged in the dielectric substrate 306, and does not contact the patch arrangement 302. The disc-loaded feed probe 1410 includes a probe portion 1410A extending generally perpendicular to the dielectric substrate 306 and a disc-shaped portion 140B (e.g., cylindrical disc) connected at the top end of the probe portion 140A and arranged generally perpendicularly to the probe portion 1410A. The probe portion 1410A and the disc-shaped portion 1410B are generally coaxial. The probe portion 1410A may be cylindrical. The disc-loaded feed probe 1410 may overlap with the patch arrangement 302 in plan view.

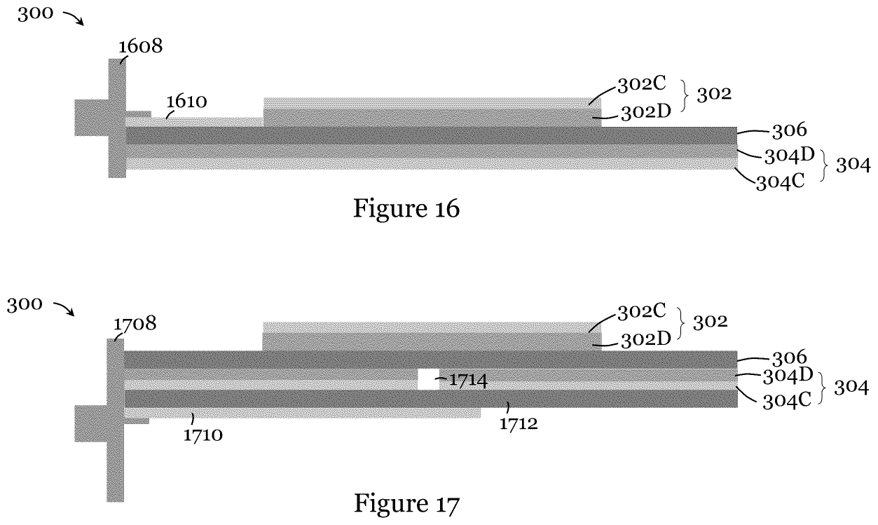

FIG. 15 shows the patch antenna 300 of FIG. 3A incorporating a hook-shaped probe feed. The structure of the patch arrangement 302, the dielectric substrate 306, and the ground plane 304 will not be repeated here.

In FIG. 15, the hook-shaped probe feed comprises a feed connector 1508 and a hook-shaped feed probe 1510 electrically connected with the feed connector 1508. The feed connector 1508 extends generally perpendicular to the dielectric substrate 306 and the ground plane 304, and it extends through the ground plane 304 and partly through the dielectric substrate 306. The feed connector 1508 may be a coaxial cable connector (e.g., SMA connector). The hook-shaped feed probe 1510 extends from the feed connector i508. The hook-shaped feed probe 1510 is arranged in the dielectric substrate 306, and does not contact the patch arrangement 302. The hook-shaped feed probe 1510 includes a first portion 1510A extending generally perpendicular to the dielectric substrate 306, a second portion 1510B extending generally perpendicularly from the first portion 1510A and generally parallel to the dielectric substrate 306, and a third portion 1510C extending generally perpendicularly from the second portion and generally parallel to the first portion. The first and third portions 1510A, 1510C extend in opposite directions. The hook-shaped feed probe 1510 may overlap with the patch arrangement 302 in plan view.

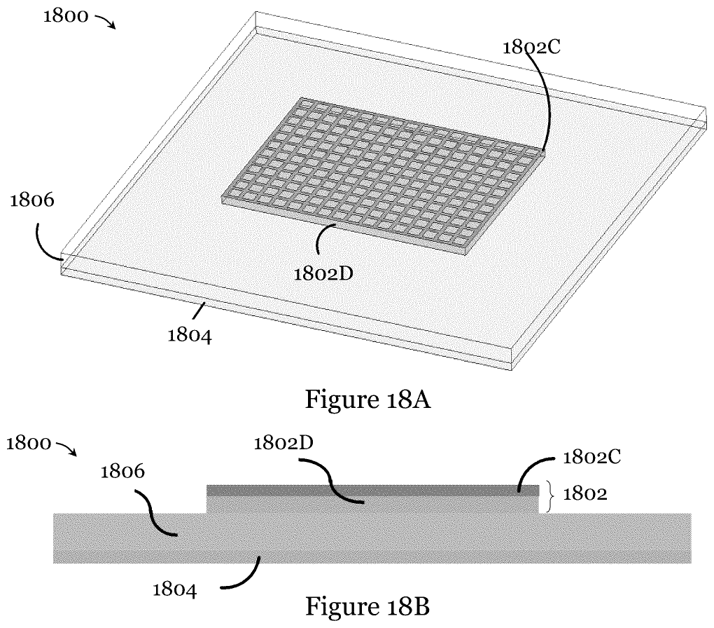

FIG. 16 shows the patch antenna 300 of FIG. 3A incorporating a stripline feed. The structure of the patch arrangement 302, the dielectric substrate 306, and the ground plane 304 will not be repeated here.

In FIG. 16, the stripline feed comprises a feed connector 1608 and a stripline 1610 electrically connected with the feed connector 1608. The feed connector 1608 is mounted laterally on one side of the patch antenna 300. The feed connector 1608 may be a SMA connector or probe. The stripline 1610 is arranged on the dielectric substrate 306, and extends between the feed connector 1608 and the patch arrangement 302. The stripline 1610 connects with the feed connector 1608 at one end and with the patch arrangement 302 at another end. The stripline 1610 is flat, and is thinner than the patch arrangement 302 or its dielectric layer 302D. The stripline 1610 does not overlap with the patch arrangement 302 in plan view. The stripline 1610 may be a substantially-transparent conductor.

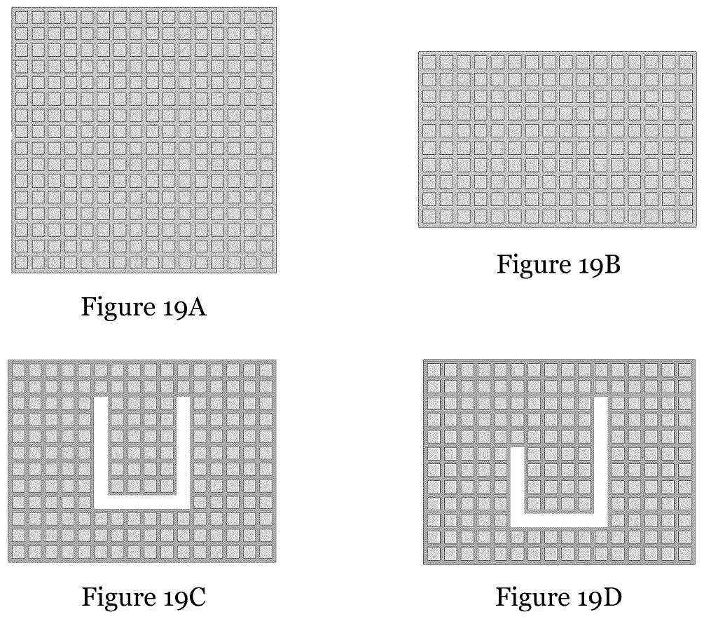

FIG. 17 shows the patch antenna 300 of FIG. 3A incorporating an aperture-coupled feed. The structure of the patch arrangement 302, the dielectric substrate 306, and the ground plane 304 will not be repeated here.

In FIG. 17, the aperture-coupled feed comprises a feed connector 1708, a feed line 1710 electrically connected with the feed connector 1708, a feed substrate 1712, and a coupling aperture 1714 formed (e.g., etched) in the ground plane 304. The feed connector 1708 is mounted laterally on one side of the patch antenna 300. The feed connector 1708 may be a SMA connector or probe. The feed substrate 1712 is arranged on the ground plane 304, on a side opposite the side with the dielectric substrate 306. The feed substrate 1712 may have the same or similar shape and size as the dielectric substrate 306. The feed substrate 1712 may be made of substantially-transparent material(s), such as air, glass, etc. The feed line 1710 is arranged on the feed substrate 1712 on a side opposite the side with the ground plane 304. The feed line 1710 extends from the feed connector 1708. The feed line 1710 is flat, and is thinner than the feed substrate 1712. In plan view the coupling aperture 1714 overlaps with the feed line 1710. The feed line 1710 may be a substantially-transparent conductor. The feed line 1710 is operably coupled with the coupling aperture 1714 formed in the ground plane 304. The coupling aperture 1714 is a through-hole formed in the ground plane 304 (i.e., both layers 304C, 304D of the ground plane 304).

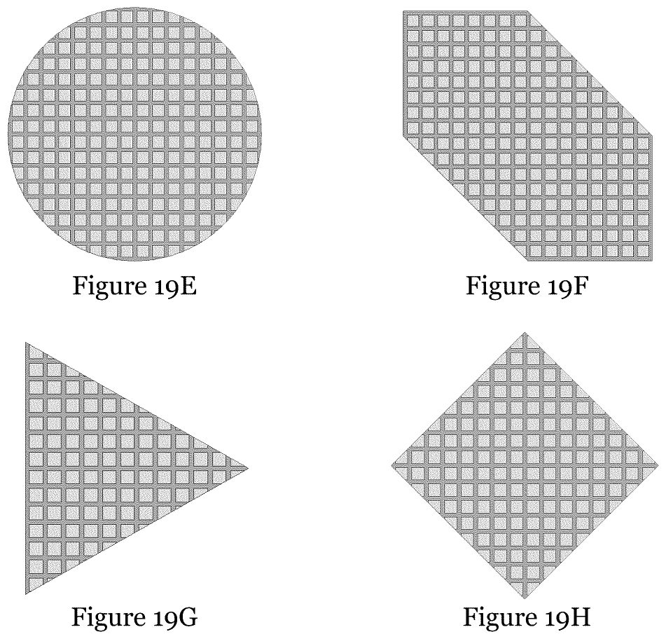

FIGS. 18A and 18B show a patch antenna 1800 in one embodiment of the invention. Generally, the patch antenna 1800 is the same as the patch antenna 100 of FIG. 1A, except that the ground plane is constructed with a different material.

The patch antenna 1800 includes a patch arrangement 1802 with a substantially-transparent dielectric layer 1802D and a substantially-transparent electrically-conductive layer 1802C, a ground plane 1804, and a dielectric substrate 1806 arranged between the patch arrangement 1802 and the ground plane 1804. In this embodiment, the ground plane 1804 includes a substantially-transparent dielectric layer, not a metallic layer. The thickness of the substantially-transparent dielectric layer can be adjusted according to specific working frequency.

The patch arrangement 1802 is the same as the patch arrangement 102. The dielectric substrate 1806 is the same as the dielectric substrate 106. The footprint arrangement of the patch antenna 1800 is also the same as the patch antenna 100. For simplicity, they will not be repeated here.

The various feed mechanisms illustrated in FIGS. 12 to 17 can be used as feed mechanism in some patch antenna embodiments, including but not limited to the patch antennas 100-600 and 1800. However, the patch antennas 100-600 and 1800 may have a feed mechanism different from those illustrated in FIGS. 12 to 17.

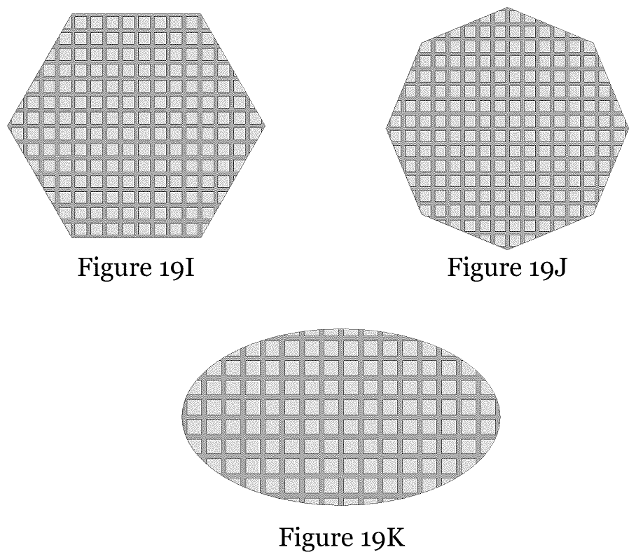

FIGS. 19A to 19J illustrate the plan view of various patch arrangement for a patch antenna in some embodiments of the invention. In FIGS. 19A to 19J, all patch 25 arrangements include a substantially-transparent electrically-conductive mesh (ITO mesh) and a pure water layer mounted below the mesh. The outline defined by the mesh and the outline defined by the pure water layer are substantially identical in plan view.

In FIG. 19A, the patch arrangement, in plan view, has a square shaped and has a square outline. The mesh layer and the pure water layer share the same outline.

In FIG. 19B, the patch arrangement, in plan view, is rectangular and has a rectangular outline. The mesh layer and the pure water layer share the same outline.

In FIG. 19C, the patch arrangement, in plan view, is rectangular and has a rectangular outline. The patch arrangement includes a generally U-shaped slot near the center of the patch arrangement. The generally U-shaped slot has an axis of symmetry. The generally U-shaped slot extends through both the mesh layer and the pure water layer. The mesh layer and the pure water layer share the same outline.

In FIG. 19D, the patch arrangement, in plan view, is rectangular and has a rectangular outline. The patch arrangement includes a generally U-shaped slot near the center of the patch arrangement. The generally U-shaped slot has no axis of symmetry. The generally U-shaped slot extends through both the mesh layer and the pure water layer. The mesh layer and the pure water layer share the same outline.

In FIG. 19E, the patch arrangement, in plan view, is circular and has a circular outline. The mesh layer and the pure water layer share substantially the same outline.

In FIG. 19F, the patch arrangement, in plan view, has a long-hexagon shape and has a long-hexagonal outline. The mesh layer and the pure water layer share substantially the same outline.

In FIG. 19G, the patch arrangement, in plan view, is triangular and has a triangular outline. The mesh layer and the pure water layer share substantially the same outline.

In FIG. 19H, the patch arrangement, in plan view, has a diamond shape and has a diamond-shaped outline. The mesh layer and the pure water layer share substantially the same outline.

In FIG. 19I, the patch arrangement, in plan view, is hexagonal and has a hexagonal outline. The mesh layer and the pure water layer share substantially the same outline.

In FIG. 19J, the patch arrangement, in plan view, is octagonal and has a hexagonal outline. The mesh layer and the pure water layer share substantially the same outline.

In FIG. 19K, the patch arrangement, in plan view, is elliptical and has an elliptical outline. The mesh layer and the pure water layer share substantially the same outline.

The various patch arrangements illustrated in FIGS. 19A to 19K can be used as patch arrangement in some patch antenna embodiments, including but not limited to the patch antennas 100-600 and 1800.

The patch antenna embodiments of the invention advantageously incorporates a patch arrangement that has a substantially-transparent dielectric layer (e.g., liquid, water) and a substantially-transparent electrically-conductive layer (e.g., mesh) that at least partly overlap. The use of the substantially-transparent electrically-conductive layer can help to provide higher gain and radiation efficiency of the antenna (compared with using substantially-transparent dielectric layer), thereby allowing a thinner substantially-transparent dielectric layer be used in the antenna. This helps to provide a low profile patch antenna with good antenna performance. The substantially-transparent electrically-conductive layer may be thinner than the substantially-transparent dielectric layer, to lessen the reduction of the optical transparency of the patch arrangement, as the substantially-transparent dielectric layer is usually more transparent than the substantially-transparent electrically-conductive layer.

By suitably choosing the materials of the patch antenna, some embodiments of the patch antenna of the invention may provide desirable performance characteristics such as high optical transparency, low profile structure, low material cost, and/or wide impedance bandwidth.

Some embodiments of the patch antenna can generate a generally unidirectional radiation beam.

Some embodiments of the patch antenna is substantially-transparent, with the patch arrangement, dielectric substrate, and ground plane all made with substantially-transparent materials. Some parts of the feed mechanism may also be made with substantially-transparent materials.

The patch antenna design can be applied to form an antenna array. The antenna array may include multiple units of the patch antennas. The antenna array may include multiple rows and/or multiple columns. Some embodiments of such antenna array can provide high-gain fixed beam and scanned beams.

The patch antenna and antenna array of the invention can be used for cellular communication, such as 5G, 6G, or above generation communication. Some patch antenna embodiments have relatively high optical transparency and relatively thin antenna profile, which make them suitable for 5G (or above) wireless communications.

Some patch antenna embodiments can be attached or mounted to existing transparent objects such as window (e.g., of buildings), windshields (e.g., of vehicles, planes), and windscreens, which may be made of glass. Some patch antenna embodiments can be incorporated into communication device or system such as computer, phone, watch, IoT devices, etc.

It will be appreciated by persons skilled in the art that numerous variations and/or modifications may be made to the invention as shown in the specific embodiments to provide other embodiments of the invention. Some exemplary modifications of the embodiments are provided in the summary section. The described embodiments of the invention should therefore be considered in all respects as illustrative, not restrictive.

For example, in some embodiments, depending on applications or required working frequency, the shape, size (length, width, and height/thickness), form, state, and/or material of the various parts of the antenna can be different from those illustrated.

For example, in some embodiments, the patch antenna need not be a substantially-transparent or a transparent patch antenna.

For example, the substantially-transparent dielectric layer of the patch arrangement can be made of any dielectric material(s), in any state, that is substantially-transparent. The substantially-transparent electrically-conductive layer of the patch arrangement can be made of any electrically-conductive material(s), in any state, that is substantially-transparent. The dielectric substrate can be made of any dielectric material(s), in any state, which may or may not be substantially-transparent. The ground plane can be made at least partly of conductor(s), e.g., metallic surfaces, substantially-transparent conductors, etc. In examples in which the ground plane includes a substantially-transparent dielectric layer and a substantially-transparent electrically-conductive layer: the substantially-transparent dielectric layer of the patch arrangement can be made of any dielectric material(s), in any state, that is substantially-transparent; and the substantially-transparent electrically-conductive layer of the patch arrangement can be made of any electrically-conductive material(s), in any state, that is substantially-transparent. The materials for various parts of the patch antenna can be chosen based on ease of fabrication, material cost, and desired electrical and optical performance. In some examples pure water and indium-tin-oxide (ITO) are used as they are readily-available materials with high optical transparency. Other materials may be use in other examples.

In some embodiments, the substantially-transparent mesh may be formed by etching holes or slots on or in a substantially-transparent conductor.

In some embodiments, the patch antenna may include additional layer(s) of material(s) (e.g., in addition to those illustrated).

In some implementations, fluid (gaseous or liquid) material(s) or layer(s) of the patch antenna may be provided by fluid contained in, e.g., filled in, a space defined by a structure, such as a support frame. The support frame may have define one or more such spaces, and optionally one or more input and output port(s) to those spaces. The support frame may be made of one or more materials that is substantially-transparent. In one example, the support frame is made by glass or thermoplastic (e.g., plexiglass). In some examples, the patch antenna may include one or more such support frames operably coupled or coupleable with each other.

1. A patch antenna comprising:
a patch arrangement;
a ground plane;
a dielectric substrate disposed between the patch arrangement and the ground plane; and
a feed mechanism for feeding the patch antenna;
wherein the patch arrangement comprises a substantially-transparent dielectric layer and a substantially-transparent electrically-conductive layer that at least partly overlap in plan view.

2. The patch antenna of claim 1, wherein, in plan view, the substantially-transparent dielectric layer defines a first outline and the substantially-transparent electrically-conductive layer defines a second outline substantially identical to the first outline.

3. The patch antenna of claim 1, wherein the substantially-transparent electrically-conductive layer comprises one or more solid materials.

4. The patch antenna of claim 3, wherein the substantially-transparent electrically-conductive layer comprises an electrically-conductive mesh.

5. The patch antenna of claim 4, wherein the electrically-conductive mesh is made of a conductive oxide.

6. The patch antenna of claim 4, wherein the substantially-transparent dielectric layer comprises a liquid layer.

7. The patch antenna of claim 6, wherein the liquid layer comprises a water layer.

8. The patch antenna of claim 1, wherein the substantially-transparent dielectric layer is disposed between the dielectric substrate and the substantially-transparent electrically-conductive layer.

9. The patch antenna of claim 1, wherein the substantially-transparent electrically-conductive layer is disposed between the dielectric substrate and the substantially-transparent dielectric layer. lo. The patch antenna of claim 1, wherein the dielectric substrate is substantially-transparent.

11. The patch antenna of claim 10, wherein the dielectric substrate comprises an air layer.

12. The patch antenna of claim 10, wherein the dielectric substrate comprises a glass or thermoplastic layer.

13. The patch antenna of claim 1, wherein the ground plane is substantially-transparent.

14. The patch antenna of claim 13, wherein the ground plane comprises a substantially-transparent dielectric layer.

15. The patch antenna of claim 14, wherein the substantially-transparent dielectric layer of the ground plane comprises a liquid layer.

16. The patch antenna of claim 15, wherein the liquid layer of the ground plane comprises a water layer.

17. The patch antenna of claim 14, wherein the ground plane further comprises a substantially-transparent electrically-conductive layer, the substantially-transparent dielectric layer of the ground plane and the substantially-transparent electrically-conductive layer of the ground plane at least partly overlap in plan view.

18. The patch antenna of claim 17, wherein the substantially-transparent electrically-conductive layer of the ground plane comprises one or more solid materials.

19. The patch antenna of claim 18, wherein the substantially-transparent electrically-conductive layer of the ground plane comprises an electrically-conductive mesh.

20. The patch antenna of claim 19, wherein the electrically-conductive mesh of the ground plane is made of a conductive oxide.

21. The patch antenna of claim 17, wherein the substantially-transparent dielectric layer of the ground plane is disposed between the dielectric substrate and the substantially-transparent electrically-conductive layer of the ground plane.

22. The patch antenna of claim 17, wherein the substantially-transparent electrically-conductive layer of the ground plane is disposed between the dielectric substrate and the substantially-transparent dielectric layer of the ground plane.

23. The patch antenna of claim 1, wherein the feed mechanism comprises a probe feed mechanism that includes a feed probe arranged at least partly in the dielectric substrate, and, in plan view, the patch arrangement and the feed probe at least partly overlap.

24. The patch antenna of claim 1, wherein the feed mechanism comprises a stripline feed mechanism that includes a stripline connected with the patch arrangement, and wherein the stripline is substantially-transparent.

25. The patch antenna of claim 1, wherein the feed mechanism comprises an aperture feed mechanism that includes:
a coupling aperture formed in the ground plane, and
a feed line operably coupled with the coupling aperture;
wherein the feed line is substantially-transparent.

26. The patch antenna of claim 1, wherein the patch arrangement, the ground plane, and the dielectric substrate are substantially-transparent.

27. An antenna array comprising a plurality of patch antenna units, each of the plurality of patch antenna units having:
a patch arrangement;
a ground plane;
a dielectric substrate disposed between the patch arrangement and the ground plane; and
a feed mechanism for feeding the patch antenna unit;
wherein the patch arrangement comprises a substantially-transparent dielectric layer and a substantially-transparent electrically-conductive layer that at least partly overlap in plan view.
